(19) United States
(12) Patent Application Publication
(10) Pub. No.: US 2021/0333700 A1
(43) Pub. Date: Oct. 28, 2021

(54) PROJECTION OPTICAL APPARATUS AND PROJECTOR

(71) Applicant: SEIKO EPSON CORPORATION, Tokyo (JP)

(72) Inventor: Takahiro TAKIZAWA, Suzaka-shi (JP)

(21) Appl. No.: 17/237,251

(22) Filed: Apr. 22, 2021

(30) Foreign Application Priority Data
Apr. 22, 2020 (JP) 2020-075883

(51) Int. Cl. G03B 21/28; G02B 13/16; G03B 21/16; G02B 7/182

(52) U.S. Cl. CPC G03B 21/28; G02B 7/182; G03B 21/16; G02B 13/16

(57) ABSTRACT

A projection optical apparatus includes a projection system including a first reflector and a lens barrel accommodating the projection system. The lens barrel includes a frame including a flange and accommodating the projection system and a holder holding the first reflector. The holder has a holding surface holding the first reflector and an extension part extending from the holding surface in a direction that intersects the holding surface, the extension part being fitted to the flange. The holder differs from the frame in terms of material.

The present application is based on, and claims priority from JP Application Serial Number 2020-075883, filed Apr. 22, 2020, the disclosure of which is hereby incorporated by reference herein in its entirety.

### BACKGROUND

### 1. Technical Field

The present disclosure relates to a projection optical apparatus and a projector.

### 2. Related Art

There has been a known deflection-type projection optical apparatus used in a projection-type display apparatus, such as a projector. A projection optical apparatus of this type includes a projection lens and a mirror for changing the direction in which a display image to be projected is projected. For example, JP-A-2016-156986 discloses a projection optical system including two mirrors as an optical path deflector.

The projection optical system disclosed in JP-A-2016-156986, however, has a problem of a tendency to increase the manufacturing cost and weight of the optical system. In detail, to hold a plurality of mirrors and lens groups while ensuring the strength and precision of the projection optical system, a metal part, such as a die-cast aluminum part, is used as a frame. The material cost, the processing cost, and the weight of the frame therefore increase in some cases. That is, a projection optical apparatus that allows reduction in the manufacturing cost and weight of the projection optical system as compared with those in related art has been required.

### SUMMARY

A projection optical apparatus includes a projection system including a first reflector and a lens barrel accommodating the projection system. The lens barrel includes a frame including a flange and accommodating the projection system and a holder holding the first reflector. The holder has a holding surface holding the first reflector and an extension part extending from the holding surface in a direction that intersects the holding surface, the extension part being fitted to the flange. The holder differs from the frame in terms of material.

A projector includes a light source apparatus, a light modulator modulating light emitted from the light source apparatus, and the projection optical apparatus described above projecting the light modulated by the light modulator.

### BRIEF DESCRIPTION OF THE DRAWINGS

FIG. 1 is a schematic view showing the configuration of a projector according to a first embodiment.

FIG. 2 is a perspective view showing the external appearance of a projection optical apparatus.

FIG. 3 is a diagrammatic view showing the configuration of the projection optical apparatus.

FIG. 4 is a perspective view showing the external appearance of the assembly of a frame and a holder.

FIG. 5 is another perspective view showing the external appearance of the assembly of the frame and the holder.

FIG. 6 is a perspective view showing the external appearance of the holder.

FIG. 7 is a diagrammatic view showing results of a simulation of the amount of displacement according to Example.

FIG. 8 is another diagrammatic view showing results of the simulation of the amount of displacement according to Example.

FIG. 9 is a diagrammatic view showing results of a simulation of the amount of displacement according to Comparable Example.

### DESCRIPTION OF EXEMPLARY EMBODIMENTS

In the following drawings, axes X, Y, and Z perpendicular to one another are drawn as required, with the direction indicated by each arrow being a positive direction and the opposite direction from the positive direction being a negative direction. In the following description, the direction +Z is called above and the direction −Z is called below in some cases.

### 1. First Embodiment

### 1.1. Configuration of Projector

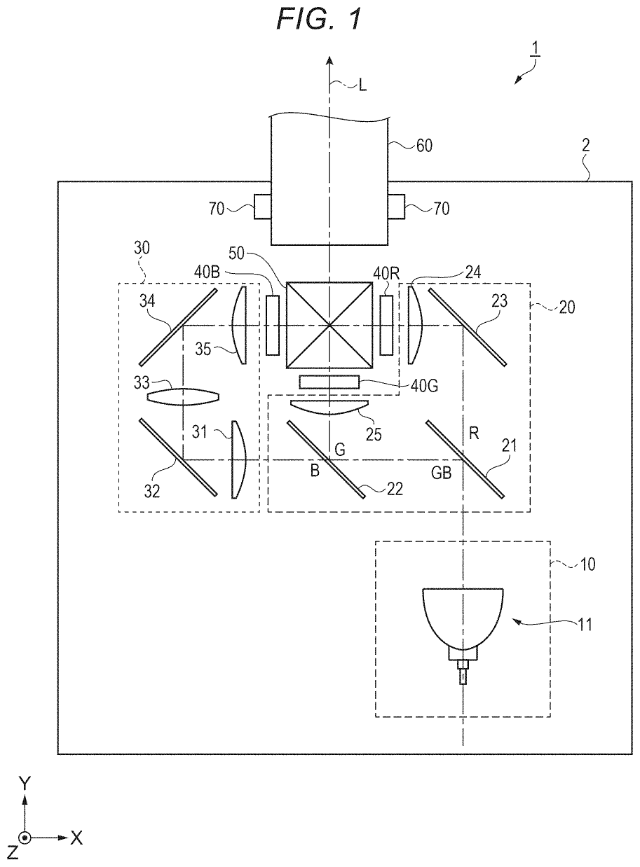

In the present embodiment, a projector 1 including three liquid crystal panels that are light modulators is presented by way of example. The configuration of the projector 1 according to the present embodiment will first be described with reference to FIG. 1.

The projector 1 includes a light source apparatus 10, a color separation system 20, a relay system 30, liquid crystal panels 40R, 40G, and 40B as the light modulators, a light combining system 50, and a projection optical apparatus 60 with the components described above accommodated in a main body 2, as shown in FIG. 1. The liquid crystal panels 40R, 40G, and 40B modulate light outputted from the light source apparatus 10. The projection optical apparatus 60 projects the light modulated by the liquid crystal panels 40R, 40G, and 40B. The projection optical apparatus 60 is an example of the projection optical apparatus according to the present disclosure.

The light source apparatus 10 includes a light source 11. The light source 11 is a discharge-type lamp and outputs light to the color separation system 20. In the light source apparatus 10, an optical integration system that is not shown but includes a fly-eye lens, a polarization converter and other components is provided between the light source 11 and the color separation system 20. The light source 11 is not limited to a discharge-type lamp and may instead be a solid-state light source, such as a light emitting diode and a laser.

The color separation system 20 includes dichroic mirrors 21 and 22, a reflection mirror 23, and field lenses 24 and 25. The light that comes from the light source apparatus 10 and enters the color separation system 20 is separated by the dichroic mirrors 21 and 22 into three color light fluxes that belong to wavelength regions different from one another. The three color light fluxes are R light, which is substantially red light, G light, which is substantially green light, and B light, which is substantially blue light.

The dichroic mirror 21 transmits the R light and reflects the G light and the B light. The R light having passed through the dichroic mirror 21 is reflected off the reflection mirror 23, passes through the field lens 24, and illuminates the liquid crystal panel 40R for R light.

The dichroic mirror 22 transmits the B light and reflects the G light. The G light reflected off the dichroic mirror 22 passes through the field lens 25 and illuminates the liquid crystal panel 40G for G light. The B light having passed through the dichroic mirror 22 enters the relay system 30.

The relay system 30 includes a light-incident-side lens 31, reflection mirrors 32 and 34, a relay lens 33, and a light-exiting-side lens 35 as a field lens. The B light tends to have an optical path and a light flux longer and greater than those of the R light and the G light. To handle the situation described above, the relay lens 33 suppresses an increase in the diameter of the light flux. The reflection mirror 32 reflects the B light incident from the color separation system 20, and the light-incident-side lens 31 causes the B light to converge in the vicinity of the relay lens 33. The B light then diverges toward the reflection mirror 34 and the light-exiting-side lens 35. The B light reflected off the reflection mirror 34 passes through the light-exiting-side lens 35 and illuminates the liquid crystal panel 40B for B light.

The liquid crystal panels 40R, 40G, and 40B convert the color light fluxes incident via the light incident surfaces thereof into light fluxes having intensities according to corresponding image signals and output the converted light fluxes to the light combining system 50. The liquid crystal panels 40R, 4GG, and 40B are each a transmissive liquid crystal panel.

The liquid crystal panels 40R, 40G, and 40B as the light modulators are not necessarily transmissive but may be reflective. Digital micromirror devices or the like may instead be employed as the light modulators. Further, the configuration in which a light modulator is provided for each of the plurality of color light fluxes is not necessarily employed, and a single light modulator may modulate the plurality of color light fluxes in a time division manner.

The light combining system 50 is a cross dichroic prism and combines the converted color light fluxes incident from the liquid crystal panels 40R, 40G, and 40B with one another. The three converted color light fluxes, the converted R light, G light, and B light, thus produce combined light L, which displays a color image. The combined light L exits toward the projection optical apparatus 60.

The projection optical apparatus 60 is attached to the main body 2 via a lens attachment section 70. The projection optical apparatus 60 is attachable to and detachable from the main body 2. The combined light L having entered the projection optical apparatus 60 is enlarged and displayed as image light via the projection optical apparatus 60 on a projection target that is not shown, such as a screen.

### 1.2. Configuration of Projection Optical Apparatus

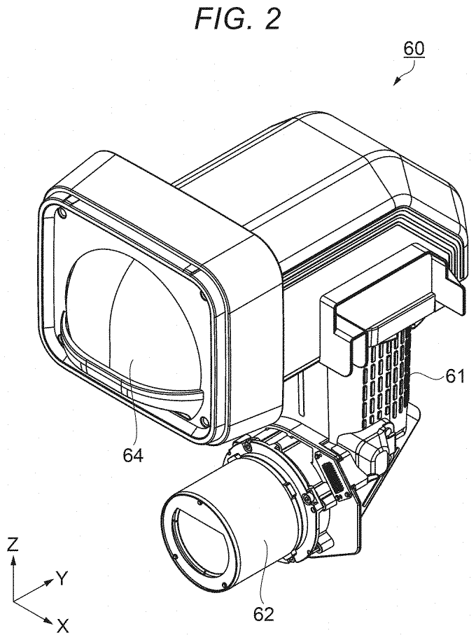

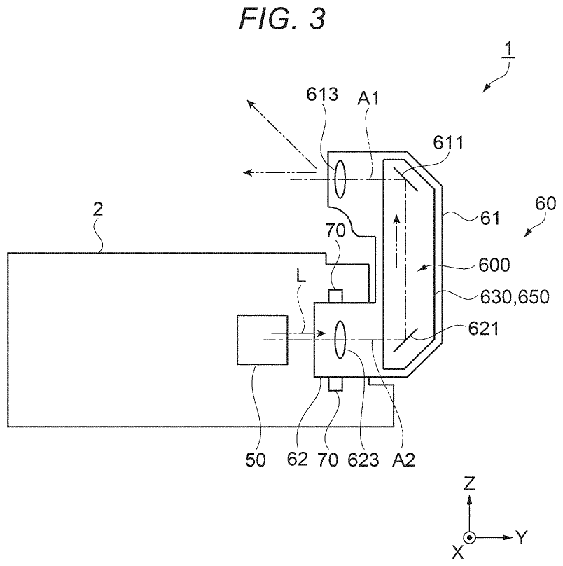

The configuration of the projection optical apparatus 60 will be described with reference to FIGS. 2 and 3. In FIG. 3, the components excluding the projection optical apparatus 60, the light combining system 50 in the main body 2, and the lens attachment section 70 are omitted.

The projection optical apparatus 60 is a deflection-type projection lens and includes an optical system so bent as to have a substantially U-letter-like shape in the plan view viewed in the direction +X, as shown in FIG. 2. A cylindrical section 62 oriented in the direction −Y is provided at the lower end of the projection optical apparatus 60. When the projection optical apparatus 60 is attached to the main body 2, the cylindrical section 62 is inserted into the lens attachment section 70 described above.

An openable/closable Lens cover 64 is provided at the upper end of the projection optical apparatus 60. FIG. 2 shows the state in which the lens cover 64 is closed. The lens cover 64 is open when the projection optical apparatus 60 is used, and the image light exits via the opening, whereas the lens cover 64 is closed when the projection optical apparatus 60 is not used to protect the interior of the projection optical apparatus 60. The lens cover 64 may be attachable to and detachable from the projection optical apparatus 60.

A lens barrel 61 is provided between the cylindrical section 62 and the lens cover 64. A projection system that will be described later and other components are disposed in the lens barrel 61.

The cylindrical section 62 of the projection optical apparatus 60 is inserted into the lens attachment section 70 and attached to the main body 2, as shown in FIG. 3. The combined light L having exited in the direction +Y out of the light combining system 50 enters the projection optical apparatus 60 via an end surface of the cylindrical section 62 that is the end surface facing the negative side of direction Y.

The projection optical apparatus 60 includes a projection system 600 and the lens barrel 61, which accommodates the projection system 600. The projection optical apparatus 60 successively deflects through two steps the combined light L incident from the light combining system 50. The combined line L is therefore reversed and exits as the image light out of the projector 1 in the direction −Y.

The projection system 600 includes a first reflector 611, a second reflector 621, a first lens group 613/ and a second lens group 623. The first lens group 613 is disposed on a rear stage of the first reflector 611. The second reflector 621 is disposed on a front stage of the first reflector 611. The second lens group 623 is disposed on the front stage of the second reflector 621. The first reflector 611 is so disposed that the end thereof facing the negative side of the direction Y rises by about 45 degrees with respect to the plane X-Y. The second reflector 621 is so disposed that the end thereof facing the positive side of the direction Y rises by about 45 degrees with respect to the plane X-Y.

In the present specification, the front stage is the side close to the light source apparatus 10, and the rear stage is the side far from the light source apparatus 10, that is, the side close to a projection target. Therefore, the front stage is the reduction side of the projection system 600, and the rear side is the enlargement side of the projection system 600. That is, the components that form the projection system 600 are arranged in the following order in the direction in which the combined light L travels: the second lens group 623; the second reflector 621; the first reflector 611; and the first lens group 613. FIG. 3 shows only a lens of the second lens group 623 that is the lens closest to the light combining system 50 and a lens of the first lens group 613 that is the lens closest to the projection target and does not show the other lenses.

The lens barrel 61 includes a frame 630 and a holder 650. The frame 630 accommodates the projection system 600. FIG 3 shows the configuration in which the frame 630 accommodates the first reflector 611 and the second reflector 621 of the projection system 600, but not necessarily. The frame 630 may further accommodate the first lens group 613 and the second lens group 623. The frame 630 and the holder 650 will be described later in detail.

The first reflector 611 and the second reflector 621 deflect the optical path of the combined light L in such a way that an optical axis A1 of the first lens group is substantially parallel to an optical axis A2 of the second lens group. In detail, the combined light L having entered the projection optical apparatus 60 travels along the optical axis A2 of the second lens group 623 and reaches the second reflector 621. The second reflector 621 reflects and deflects the combined light L in such a way that the combined light L travels in the direction substantially perpendicular to the optical axis A2 and substantially extends along the axis Z. The combined light L reflected off the second reflector 621 reaches the first reflector 611. The first reflector 611 reflects and deflects the combined light L in such a way that the combined light L travels in the direction substantially perpendicular to the axis Z and substantially extends along the axis Y. The combined light L reflected off the first reflector 611 travels along the optical axis A1 and enters the first lens group 613.

The first lens group 613 enlarges the light flux of the combined light L incident from the side facing the positive side of the direction Y and causes the combined light L to exit toward the negative side of the direction Y. The combined light L having exited out of the first lens group 613 then forms enlarged image light, which is projected via the projection optical apparatus 60 in the form of swing and tilt projection toward a region above the projector 1 and facing the negative side of the direction Y.

A third lens group maybe disposed in the optical path between the first reflector 611 and the second reflector 621. The third lens group can increase or decrease the light flux width of the combined light L reflected off the second reflector 621 and directed toward the first reflector 611.

The projection optical apparatus 60 shortens the focal length of the projector 1 as compared with that of a projector including a non-deflection-type projection lens. Using the deflection-type projection optical apparatus 60 allows projection in a position close to the projection target. The deflection-type projection optical apparatus 60 does not necessarily have the configuration described above and may have any configuration that can deflect the optical path of the combined light L outputted from the main body 2 and output the deflected combined light L.

### 1.3. Configurations of Frame and Holder

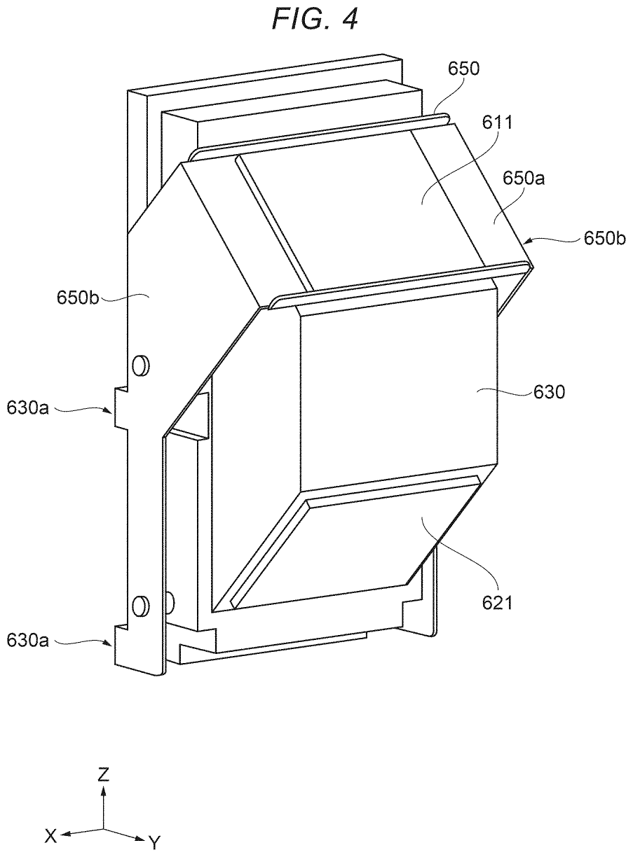

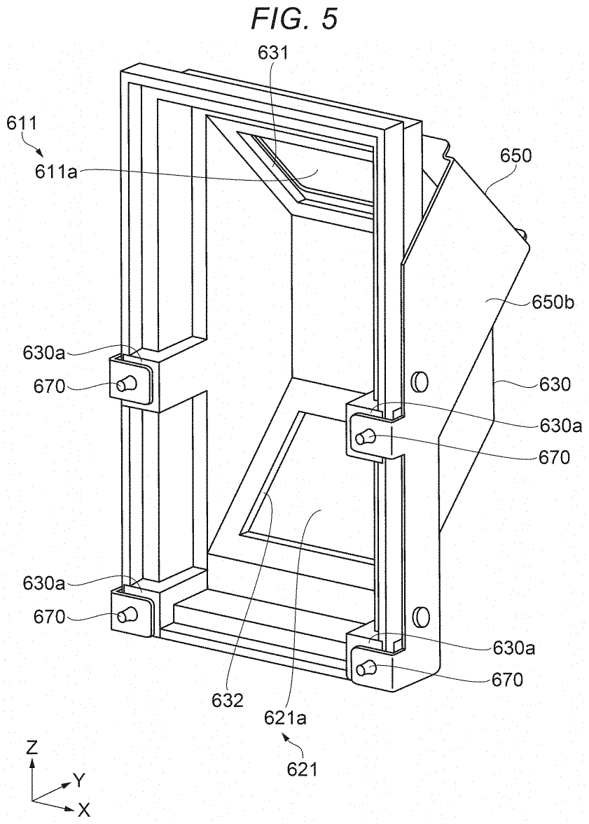

The configurations of the frame 630 and the holder 650 will be described with reference to FIGS. 4 to 6. The frame 630 and the holder 650 are assembled into an integrated unit, as shown in FIGS. A and 5.

The frame 630 has a substantially trapezoidal shape in the plan view in the direction +X, and the bottom base facing the negative side of the direction Y is longer than the upper base facing the positive side of the direction Y. The frame 630 has a quadrangular columnar shape having a bottom surface having the trapezoidal shape described above, and the direction along the axis X coincides with the height direction of the quadrangular column. A region of the frame 630 that is the region corresponding to the bottom base described above has a rectangular-frame-like shape in the plan view in the direction −Y.

The frame 630 has four flanges 630a in the direction -Y of the frame-shaped region described above. In detail, the flanges 630a are formed of two flanges at the two lower corners in the frame-shaped region described above and two frames facing each other in the direction along the axis X at approximately middle of the frame-shaped region in the direction along the axis Z in the plan view in the direction −Y. The number and arrangement of flanges 630a are not limited to those described above.

Extensions 650b, which will be described later, of the holder 650 are fit to the four flanges 630a. In addition to the fitting, the extension parts 650b are fixed to the four flanges 630a with a screw 670 for each thereof. The fixtures that fix the extension part 650b to the flanges 630a are not limited to the screws 670.

The frame 630 has a substantially quadrangular columnar shape as described above and has a surface open toward the negative side of the direction Y. In the portions corresponding to the legs of the trapezoidal shape described above, the upper surface is provided with an opening 631, and the lower surface is provided with an opening 632. A first surface 611a, which is the reflection surface of the first reflector 611, is exposed via the opening 631 to a side of the frame 630 that is the side facing the negative side of the direction Y, that is, the inner side of the frame 630. Although will be described later in detail, the first reflector 611 is held by the holder 650.

The second reflector 621 is attached to a portion where the opening 632 is provided, and a reflection surface 621a of the second reflector 621 is exposed to the inner side of the frame 630. The first surface 611a and the reflection surface 621a form the optical path of the combined light L described above in the internal space of the frame 630.

The holder 650 has a holding surface 650a and the extension parts 650b. The first reflector 611 is held at the holding surface 650a. The holding surface 650a along with the first reflector 611 covers the opening 631 of the frame 630. The extension parts 650b extend from the holding surface 650a in a direction that intersects the holding surface 650a at substantially right angles. That is, the holder 650 is fixed to the flanges 630a of the frame 630, and the pair of extension parts 650b, which extend from the flanges 630a, support the holding surface 650a in such a way that the holding surface 650a covers the opening 631 in the form of a bridge.

The holder 650 differs from the frame 630 in terms of material. The material of the holder 650 preferably has rigidity higher than the rigidity of the material of the frame 630. The holder 650 therefore has relatively high rigidity and can therefore more precisely hold the first reflector 611. The rigidity used herein is, for example, flexural rigidity.

Specifically, examples of the material of the holder 650 may include stainless steel, an aluminum alloy, and other metals. Further, the holder 650 is preferably formed of a member manufactured by sheet metal working using a flat plate. The manufacturing cost of the holder 650 can thus be lowered as compared, for example, with a case where the holder 650 is manufactured by casting.

Examples of the material of the frame 630 may include acrylonitrile-butadiene-styrene copolymer resin, polycarbonate resin, polyacetal resin, polyphenylene ether resin, polybutylene terephthalate resin, polysulphone resin, polyether ether ketone resin, fluororesin, liquid crystal polymer and other aromatic polyester resins, and polyphenylene sulfide resin and other resins. The frame 630 may contain fillers, such as glass fibers, or an additive as well as any of the resins described above.

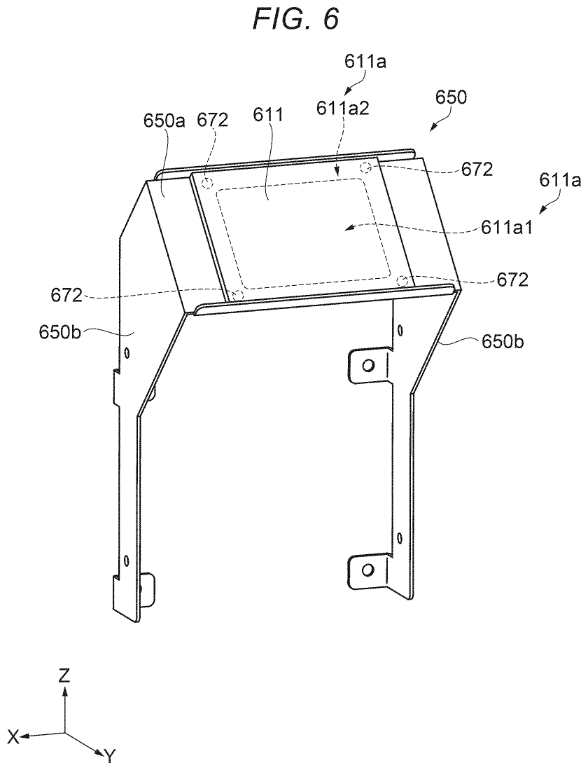

The holder 650 includes a plurality of bonding sections 672 as a fixture for fixing the first reflector 611 to the holder 650, as shown in FIG. 6. In detail, the first reflector 611 has a substantially rectangular shape, and the first surface 611a, which faces the negative side of the direction Y, has a first region 611a1 and a second region 611a2. The first region 611a has a substantially rectangular shape and is disposed inside the second region 611a2 provided in a frame-like shape along the outer circumference of the first surface 611a. When the frame 630 and the holder 650 are assembled, the opening 631 and the first region 611aare so disposed that the first region 611a1 is overlaid on the opening 631. The first region 611a1 is therefore exposed to the interior of the frame 630. That is, the first region 611a1 reflects via the opening 631 the combined light L as the light that reaches from the second reflector 621.

The bonding sections 672 are so disposed at the four corners of the first surface 611 that one adhesive section 672 is disposed at one corner. The second region 611a2 is fixed to the holding surface 650a via the four bonding sections 672. That is, the four bonding sections 672 bond and fix the second region 611a2 to the holder 650. The bonding is performed, for example. by using an adhesive, such as a UV-curing adhesive, as follows: The UV-curing adhesive is applied to the four bonding sections 672 of the holding surface 650a, and the first reflector 611 is then temporarily placed on the holding surface 650a; and fine adjustment of the position of the first reflector 611 is then made, and the UV-curing adhesive is then irradiated with ultraviolet rays to cure and fix the first reflector 611. The method for fixing the second reflector 621 to the frame 630 is not limited to a specific method. For example, the same method for fixing the first reflector 611 may be employed.

The number and arrangement of bonding sections 672 are not limited to those described above. The method for fixing the first reflector 611 to the holder 650 is not limited to bonding, and a fixing method using screws or a sheet metal member may be employed.

The present embodiment can provide the effects below.

The manufacturing cost and weight of the projection optical apparatus 60 can be lowered as compared with those in related art. In detail, the holder 650 and the frame 630 are made of materials different from each other and assembled. Therefore, the holder 650 can be made of a relatively robust material that precisely holds the first reflector 611, and the frame 630 can be made of a relatively light material. The total weight of the frame 630 and the holder 650 can therefore be suppressed.

The shapes of the frame 630 and the holder 650 can be simplified and therefore the processing cost and other factors can be reduced as compared with a case where the frame 630 and the holder 650 are integrally manufactured in die casting. In addition to the above, materials according to the characteristics required for the frame 630 and the holder 650 can be selected also in consideration of the material cost and other factors. The manufacturing cost of the frame 630 and the holder 650 can therefore be suppressed. A projection optical apparatus 60 manufactured at low cost and having a small weight can thus be provided.

Since the holder 650 is made of metal and the frame 630 is made of resin, the holder; 650 can further precisely hold the first reflector 611. At the same time, the weight of the frame 630 is reduced, and the total weight of the frame 630 and the holder 650 can therefore be further reduced. Further, the frame 630 can be readily formed, for example, in injection molding, whereby the processing cost and other factors can be further reduced. Moreover, the material cost of the frame 630 can be suppressed.

Since the plurality of bonding sections 672 as the fixture are provided, the first reflector 611 can be reliably fixed to the holder 650. Since the second region 611a2 is fixed to the holder 650, the first region 611a1 is not blocked, whereby the reflection of the combined light L is not hindered. Further, since the second region 611a2 is fixed to the holder 650 via bonding, the first reflector 611 can be readily fixed as compared with a case where the first reflector 611 is fixed with screws or via fitting.

When the projection optical apparatus 60 is used in the projector 1, the direction in which the projection optical apparatus 60 projects an image or any other object is deflected by about 180° in the plan view in which the projection optical apparatus 60 is viewed in the direction +Z. The projector 1 can therefore be installed with improved flexibility. Further, a projector 1 that is lightweight and excels in manufacturing cost can be provided.

### 1.4. Example and Comparable Example

Example and Comparable Example will be presented below to more specifically describe the effects of the present disclosure. The present disclosure is not at all restricted by Example below.

The assembly of the frame 630 and holder 650 according to Example and an integrated member according to Comparable Example were prepared, and simulations were carried out on the distribution of the amount of displacement that occurred at a temperature difference of 20° C. between 25° C. and 45° C. In the following description, the assembly of the frame 630 and holder 650 according to Example is called a unit 690, and the integrated member according to Comparable Example, which corresponds to the unit 690 according to Example, is called a unit 990.

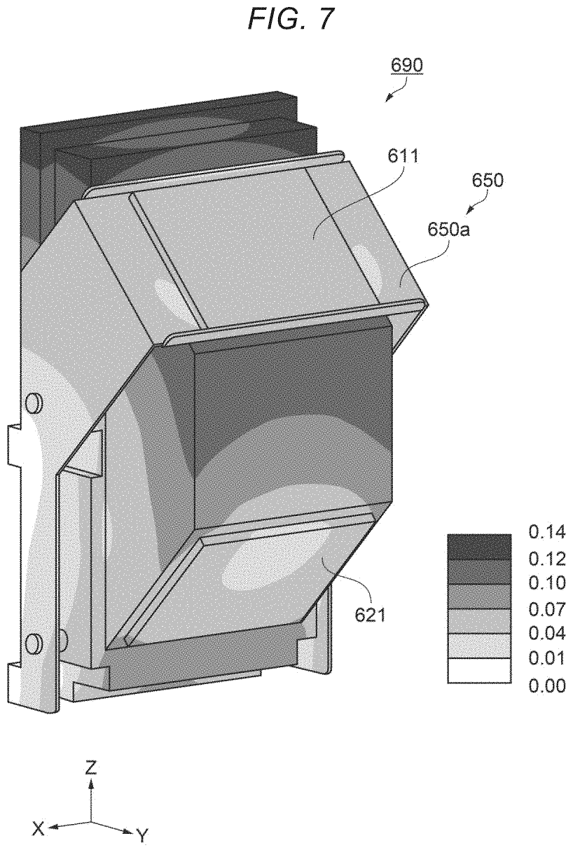

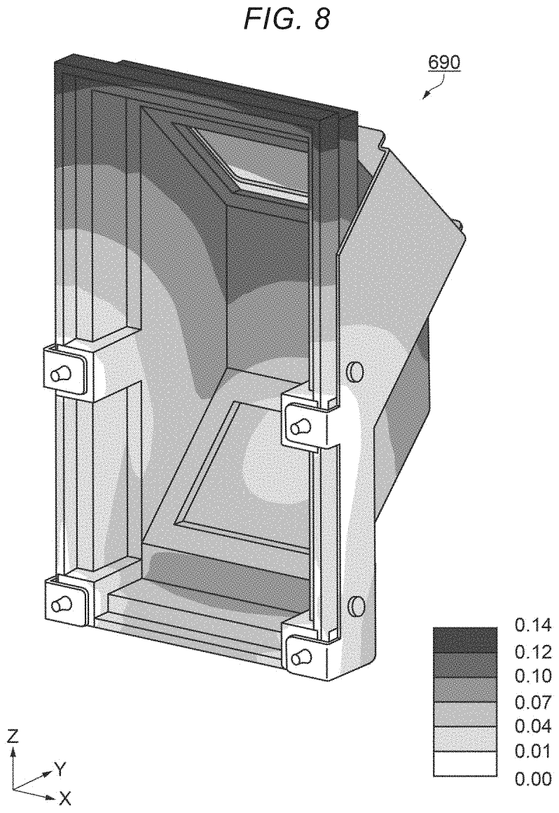

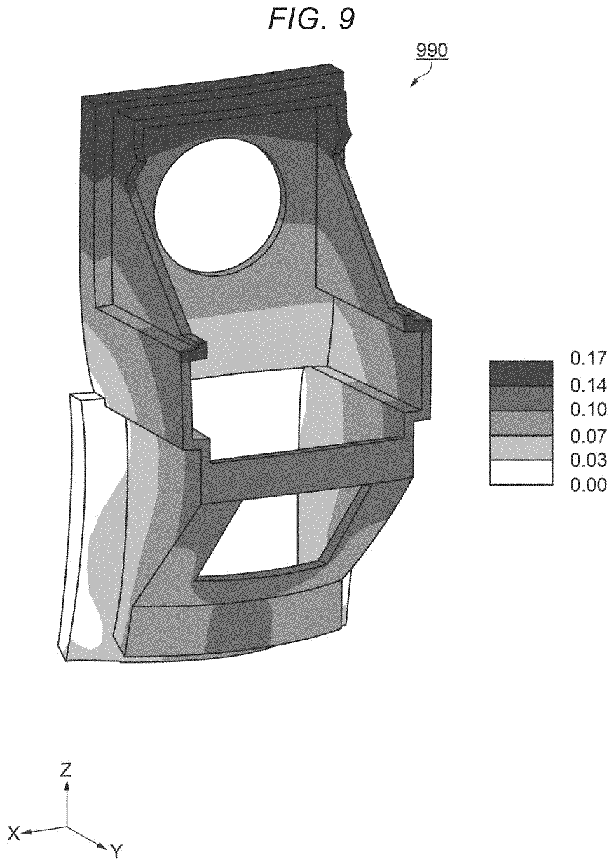

Specifically, the unit 690 according to Example was the assembly of two members, the frame 630 formed of a polycarbonate resin (PC-GF30) member containing 30 mass % of glass fibers and the holder 650 formed of a SUS304 sheet metal member. The unit 990 according to Comparable Example is formed of members having an overall shape that approximates the shape of the unit 690 according to Example and integrated with each other via PC-GF30. In the simulation on Example, the flanges 630a described above were used as a reference, that is, a fixed position. In the simulation on Comparable Example, a portion corresponding to the flanges 630a in Example was used as a reference. FIGS. 7 and 8 show results of the simulation of the amount of displacement in the unit 690 according to Example. FIG. 9 shows results of the simulation of the amount of displacement in the unit 990 according to Comparable Example.

In FIGS. 7 to 9, the amount of displacement is expressed in the form of gradations, with the amount of displacement having a unit of mm. FIGS. 7 to 9 show that the denser the gradation, the greater the amount of displacement due to the temperature difference. FIGS. 7 and 8 differ from FIG. 9 in terms of thresholds that define the boundaries between gradations. In Example shown in FIGS. 7 and 8, the first reflector 611 and the second reflector 621 are shown. In contrast, in Comparable Example shown in FIG. 9, no mirrors that are reflectors are shown, but the presence or absence of the mirrors do not affect the results of the simulation.

In the unit 690 according to Example, an upper portion was displaced by about 0.14, which is the maximum amount of displacement, and the holding surface 650a, to which the first reflector 611 is fixed, was displaced by 0.07 mm or smaller, as shown in FIGS. 7 and 8. The reason for this is that the holder 650 is formed of a sheet metal member and is a member separate from the frame 630.

On the other hand, in the unit 990 according to Comparable Example, the upper portion was displaced by 0.15 mm or greater, as shown in FIG. 9. In addition to the above, the portions to which the reflectors were attached were displaced by about 0.14 mm. The above results suggest that in the unit 990 according to Comparable Example, the positions of the reflectors are greatly shifted by the temperature change from 25° C. to 45° C. as compared with the unit 690 according to Example.

In general, in a deflection-type projection optical apparatus, the optical axis thereof is likely to angularly shift at an angle twice the angle of incidence based on Snell's law, and the configuration employing a plurality of reflectors requires high precision as compared with a non-deflection-type projection optical apparatus. Further, when a projection optical apparatus is employed in a projector, the temperature of the atmosphere in the vicinity of the projection optical apparatus rises. In addition to the above, in a high-luminous-flux projector, which is widely used in recent years, the projection optical apparatus itself is likely to have a high temperature. In particular, the unit described above, which holds optical parts, such as a reflector, is exposed to the high temperature. Therefore, an integrated member made of an inexpensive resin, such as the unit 990 according to Comparable Example, has a difficulty maintaining the positional precision of the optical parts. The problem of the difficulty maintaining the positional precision is solved by a certain extent by forming the unit described above in die casting, but the die-cast unit causes problems of increases in the manufacturing cost and the weight of the projection optical apparatus.

In contrast, the unit 690 according to Example ensures the positional precision of the optical parts and reduces the manufacturing cost and the weight. In detail, when the holder 650 is formed of a sheet metal member, the positional precision of the optical, parts is ensured, as shown by the results of the simulations described above. Further, the unit 690, which has the two-piece configuration formed of a resin member and a sheet metal member, can be lightweight and readily manufactured as compared with an aluminum integrated member manufactured in die casting. Moreover, since the holder 650 is formed of a sheet metal member having higher thermal conductivity than, for example, that of resin, the heat of the optical parts is dissipated via the extension part 650b and other components, whereby the first reflector 511 and other components are effectively cooled. That is, employing the unit 690 can improve the optical precision of the projector 1 and improve the display quality of the projected image light.

The results described above show that the unit 690 according to Example is less sensitive to a temperature change and more capable of maintaining the positional precision of the optical parts than the unit 990 according to Comparable Example, which is an integrated molded member made of resin.

### 2. Second Embodiment

In the present embodiment, a projection optical apparatus attachable to the projector 1 according to the embodiment described above will be presented by way of example. The projection optical apparatus according to the present embodiment includes a projection system including a first reflector and a lens barrel that accommodates the projection system. The lens barrel includes a frame that has a flange and accommodates the projection system and a holder that holds the first reflector. The holder has a holding surface that holds the first reflector and an extension part that extends from the holding surface in a direction that intersects the holding surface and is fit to the flange. The holder differs from the frame in terms of material.

The projection system includes a first lens group disposed on the rear stage of the first reflector and a second lens group disposed on the front stage of the first reflector, and the first reflector deflects the optical path in such a way that the optical axis of the first lens group is substantially perpendicular to the optical axis of the second lens group.

That is, the projection optical apparatus according to the present embodiment differs from the projection optical apparatus 60 according to the first embodiment in that no second reflector is provided, deflects the combined light L incident from the projector 1 by about 90°, and projects the combined light L. The projection optical apparatus according to the present embodiment is what is called an L-letter-shaped projection optical apparatus. The present embodiment can provide the same effects as those provided by the first embodiment.

What is claimed is:

1. A projection optical apparatus comprising:
a projection system including a first reflector; and
a lens barrel accommodating the projection system,
wherein the lens barrel includes
a frame including a flange and accommodating the projection system and
a holder holding the first reflector, the holder has
a holding surface holding the first reflector and
an extension part extending from the holding surface in a direction that intersects the holding surface, the extension part being fitted to the flange, and
the holder differs from the frame in terms of material.

2. The projection optical apparatus according to claim 1,
Wherein a thermal conductivity of the holder is higher than a thermal conductivity of the frame.

3. The projection optical apparatus according to claim 1,
Wherein a rigidity of the material of the holder is higher than a rigidity of the material of the frame.

4. The projection optical apparatus according to claim 1,
wherein the holder is made of metal, and
the frame is made of resin.

5. The projection optical apparatus according to claim 1, further comprising
a plurality of fixtures fixing the first reflector to the holder.

6. The projection optical apparatus according to claim 5,
wherein a first surface of the first reflector has a first region reflecting light and a second region fixed to the holder via the fixtures.

7. The projection optical apparatus according to claim 6,
wherein the fixtures bond and fix the second region to the holder.

8. The projection optical apparatus according to claim 1,
wherein the projection system includes
a first lens group disposed at an enlargement side of the first reflector,
a second reflector disposed at a reduction side of the first reflector, and
a second lens group disposed at the reduction side of the second reflector, and
the first reflector and the second reflector deflect an optical path of the projection system in such a way that a first optical axis of the first lens group is substantially parallel to a second optical axis of the second lens group.

9. The projection optical apparatus according to claim 8,
wherein the projection system includes a third lens group in an optical path between the first reflector and the second reflector.

10. The projection optical apparatus according to claim 1,
wherein the projection system includes a first lens group disposed at the enlargement side of the first reflector and a second lens group disposed at the reduction side of the first reflector, and
the first reflector deflects an optical path of the projection system in such a way that a first optical axis of the first lens group is substantially perpendicular to a second optical axis of the second lens group.

11. A projector comprising:
a light source apparatus;
a light modulator modulating light emitted from the light source apparatus; and
the projection optical apparatus according to claim 1 projecting the light modulated by the light modulator.
